(19) United States
(12) Patent Application Publication
(10) Pub. No.: US 2007/0064615 A1
(43) Pub. Date: Mar. 22, 2007

(54) Methods and systems for observing digital signal output

(75) Inventor: Gregory R. Page, Pinellas Park, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/230,372

(22) Filed: Sep. 20, 2005

(51) Int. Cl. H04J 1/16; H04J 3/16

(52) U.S. Cl. 370/250; 370/466

(57) ABSTRACT

Methods and systems for digital to analog conversion are provided. In one embodiment, a system for observing data of interest communicated within a data stream is provided. The system comprises means for monitoring a stream of data packets, wherein one or more data packets of the stream of data packets contain a data value of interest from a specific data source; means for converting the data value of interest into an analog signal, wherein the analog signal is representative of the data value of interest, wherein the means for converting is responsive to the means for monitoring a stream of data packets; and means for observing the one or more analog signals to determine the affects of one or more data processing operations on the data of interest, wherein the means for observing is responsive to the means for converting.

### TECHNICAL FIELD

The present invention generally relates to sensors and more particularly to observing digital sensor output data.

### BACKGROUND

Modem sensors units, such as inertial sensors, often output their sensor data in a digital data format. Often, this digital data is transported by one or more packets in a data stream that also comprises data from multiple other sensors. When these sensors units are tested in laboratories, one characteristic of interest is data latency (i.e. the time elapsed between when a measurable event occurs and when digital data representing that event is produced by a sensor.)

A problem that arises when measuring sensor data latency is discerning between latencies of a particular sensor and latencies caused by data processing delays within laboratory test equipment. Because the data stream comprises data from the multiple sensors as well as other data such as communications protocol data, there is no way to readily observe the occurrence of an event affecting a specific sensor at a point in the data stream between the sensor unit output and the test equipment. Without the ability to observe the event within the data stream, test conductors cannot determine whether data latency reported by test equipment is caused by the sensor unit under test (UUT) or the testing equipment.

For the reasons stated above and for other reasons stated below which will become apparent to those skilled in the art upon reading and understanding the specification, there is a need in the art for a technique to isolate latency caused by a unit under test.

### SUMMARY

The Embodiments of the present invention provide methods and systems for digital to analog conversion and will be understood by reading and studying the following specification.

In one embodiment, a method for observing characteristics of data propagating through a stream of digital data is provided. The method comprises monitoring data packets communicated though the stream of digital data at one or more points in the stream of digital data; isolating data of interest from a specific data source within each of the data packets; converting the data of interest into one or more analog signals that are representative of the data of interest; and observing the one or more analog signals to determine the affects of one or more data processing operations on the data of interest.

In another embodiment, a digital to analog converter interface for observing characteristics of data propagating through a stream of digital data is provided. The interface comprises a processor adapted to input a stream of data packets from a data link, wherein the processor is further adapted to identify data of interest contained within one or more data packets of the stream of data packets; and a digital to analog converter coupled to the processor, wherein the digital to analog converter is adapted to convert the data of interest identified by the processor into an analog signal that is representative of the value of the data of interest, and wherein characteristics of the analog signal indicate the affects of one or more data processing operations on the data of interest.

In yet another embodiment, a system for observing characteristics of data of interest communicated within a data stream is provided. The system comprises means for monitoring a stream of data packets, wherein one or more data packets of the stream of data packets contain a data value of interest from a specific data source; means for converting the data value of interest into an analog signal, wherein the analog signal is representative of the data value of interest, wherein the means for converting is responsive to the means for monitoring; and means for observing the one or more analog signals to determine the affects of one or more data processing operations on the data of interest, wherein the means for observing is responsive to the means for converting.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a system for identifying data of interest in a data stream of one embodiment of the present invention;

FIG. 2 is a diagram illustrating a digital to analog converter interface of one embodiment of the present invention;

FIG. 3A is a diagram of one embodiment of the present invention for measuring response characteristics of a sensor;

FIG. 3B is a chart illustrating one embodiment of the present invention for measuring response characteristics of a sensor;

FIG. 4A is a block diagram illustrating a system for identifying data of interest in a data stream of one embodiment of the present invention;

FIG. 4B is a chart illustrating one embodiment of the present invention for identifying data of interest in a data stream of one embodiment of the present invention; and

FIG. 5 is a flow chart of a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention address the need in the art for methods and systems for finding and displaying particular data of interest in a data stream. Embodiments of the present invention enable users to pick out specific data of interest contained within a data stream comprising a multitude of data, and observe a representation of the specific data of interest. In one embodiment, such data of interest may indicate the occurrence of a particular event, as described in embodiments below.

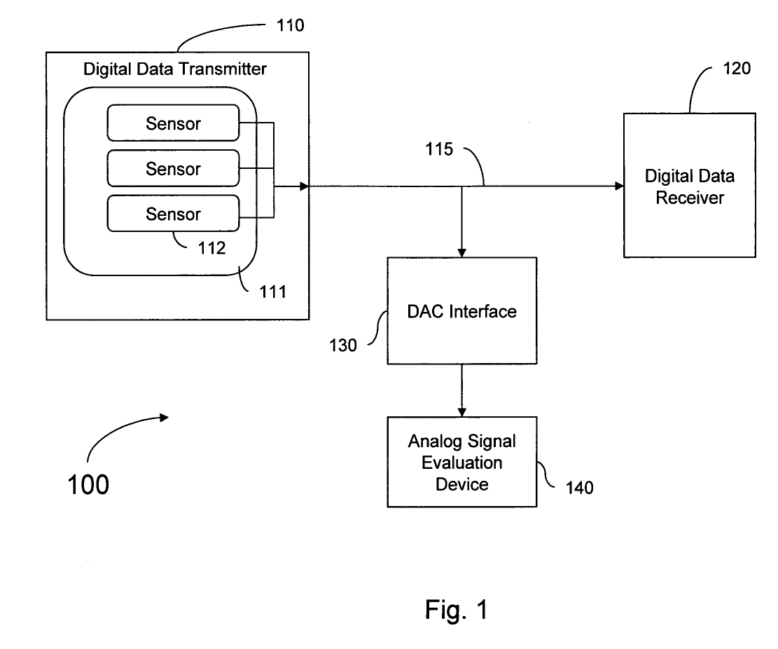

FIG. 1 illustrates a system 100 for identifying data of interest in a data stream, of one embodiment of the present invention. The system comprises a digital data transmitter 110 coupled to communicate with a digital data receiver 120 over at least one communication link 115. In one embodiment, digital data transmitter 110 comprises any device, system or network that outputs digital data, such as, but not limited to, a sensor, a sensor module comprising a plurality of sensors, a communications network, or a computer processor. In one embodiment, digital data receiver 120 comprises any device, system or network that inputs digital data, such as, but not limited to, testing and diagnostic equipment, a communications network, and a digital signal processing system. In one embodiment, the at least one communication link 115 comprises one or more of a serial data link, an RS-232 protocol link, a Mil. Std. 1553 protocol link, an Ethernet link, a TCP/IP link, an optical communications link, a wireless communications link, or any other communication link used to communicate digital data.

In one embodiment, digital data transmitter 110 comprises multiple sensors 111 such as one or more of, but not limited to, gyroscopic sensors, one or more accelerometers, one or more temperature sensors, one or more atmospheric pressure sensors. In one embodiment, each of the multiple sensors 111 output digital data in response to one or more stimulus and digital data transmitter 110 outputs the digital data from sensors 111 as a data stream on communication link 115. In one embodiment, where digital data transmitter 110 comprises a sensor unit under test, digital data receiver 120 is a computerized testing station that analyzes and records the responses of digital data transmitter 110 to stimulus from one or more external events. As previously discussed, it is difficult for digital data receiver 120 to precisely evaluate the response time (i.e. the data latency) of an individual sensor 112 within digital data transmitter 110 to external stimulus because digital data receiver 120 cannot discern between the data latency of sensor 112 and latencies caused by digital data receiver's own internal data processing delays. Such internal data processing delays reflect the time necessary for digital data receiver 120 to process and evaluate the entire contents of every data packet received in the data stream output from digital data transmitter 110, as well as process other data from the data stream such as communications protocol data.

Embodiments of the present invention enable the monitoring of data of interest communicated from sensor 112 to digital data receiver 120 in real time, prior to processing delays introduced by digital data receiver 120. Embodiments of the present invention provide an analog output representing sensor 112 data as sensor 112 data is transported by communications link 115. Observance of sensor 112 data as a real time analog signal further enables directly correlating the timing of sensor 112 data output with the timing of a stimulation event.

To provide the analog output representing sensor 112 data, system 100 further comprises digital to analog converter interface (DAC Interface) 130, coupled to read data packets from the communications link 115 data stream. In one embodiment, DAC interface 130 monitors each data packet communicated by digital data transmitter 110 to digital data receiver 120, looking only for data values of interest from a specific data source (e.g., filtering out data other than data values from sensor 112). In one embodiment, DAC interface 130 converts the data values from sensor 112 into an analog signal output (such as, but not limited to a voltage or current signal). In one embodiment, one or more analog signal evaluation devices 140, such as, but not limited to, an oscilloscope, a voltage meter, an ammeter, or a timer, are coupled to input the analog signal output from DAC interface 130.

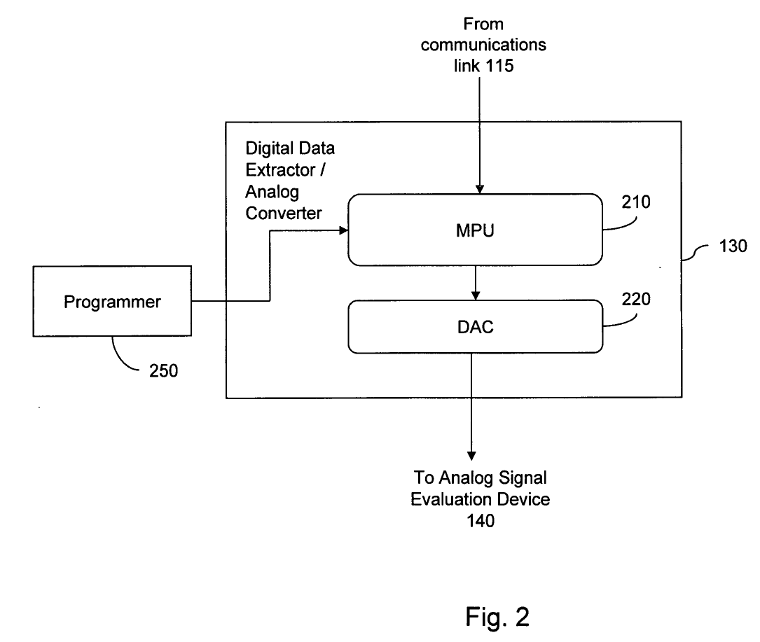

As illustrated in FIG. 2, in one embodiment, DAC interface 130 comprises a microprocessor unit (MPU) 210 coupled to a digital to analog converter (D/A) 220. In one embodiment, DAC interface 130 is programmed to monitor and capture digital data transmitted over communications link 115 via a data protocol such as RS-232, Mil. Std 1553, Manchester, or any other serial data protocol. In one embodiment, DAC interface 130 is programmed to capture digital data from a simple discrete input (e.g., +5 volts signal high, 0 volts signal low). In one embodiment, MPU 210 reads an incoming data stream of digital data transmitted over communications link 115. In one embodiment, MPU 210 runs at 50 million instructions per second and can respond to data packets within 20 nanoseconds. When a data value of interest is found (e.g., data from sensor 112), MPU 210 sends the data value to D/A 220. As would be appreciated by one skilled in the art upon studying this specification, there are a number of means available for identifying data of interest within a data packet. For example, in one embodiment, the data of interest is always located within specific word or bit locations within a data packet. In another embodiment, a data packet contains a data flag, such as a bit value, or a sensor identification code, that indicates whether or not the data packet contains data from the data source being monitored.

In one embodiment, D/A 220 is a 16 bit serial digital to analog converter. In one embodiment, the data from MPU 210 is sent at 5 megabits per second so that transfer of the data value to D/A 220 is completed within 3.2 microseconds. In one embodiment, the settle time of D/A 220 is 25 microseconds so that the total latency built into DAC interface 130 is a maximum of 28.2 microseconds. In one embodiment, D/A 220 outputs a voltage that is in direct relation to the numeric value of the data provided by MPU 210. In one embodiment, a programmer 250 is coupled to MPU 210 to configure MPU 210 to identify which data values within a stream of data packets is the data value of interest. In one embodiment, programmer 250 configures MPU 210 to look for data of interest within specific words or bits of a data packet. In one embodiment, programmer 250 configures MPU 210 to look for data associated with a specific data source, as indicated by a data flag, or a sensor identification code.

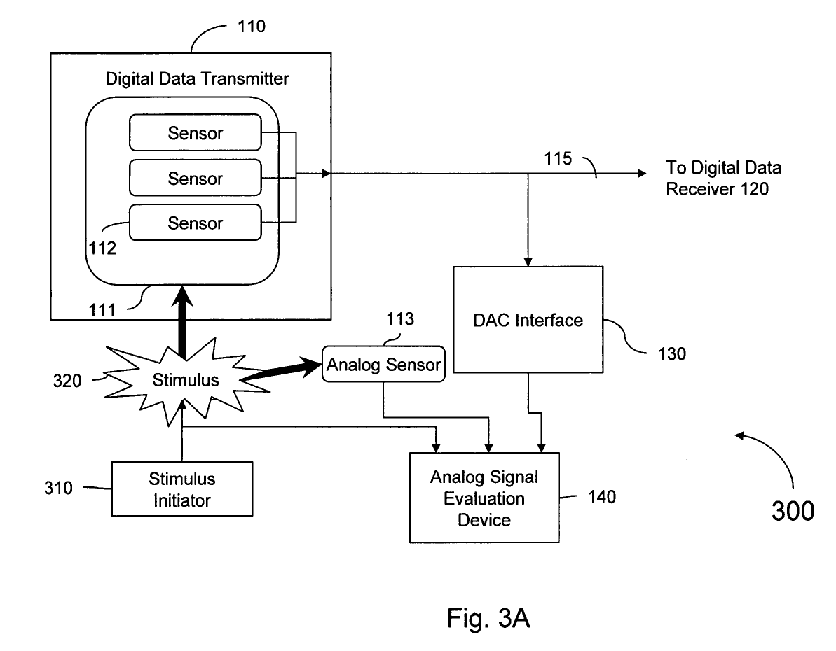

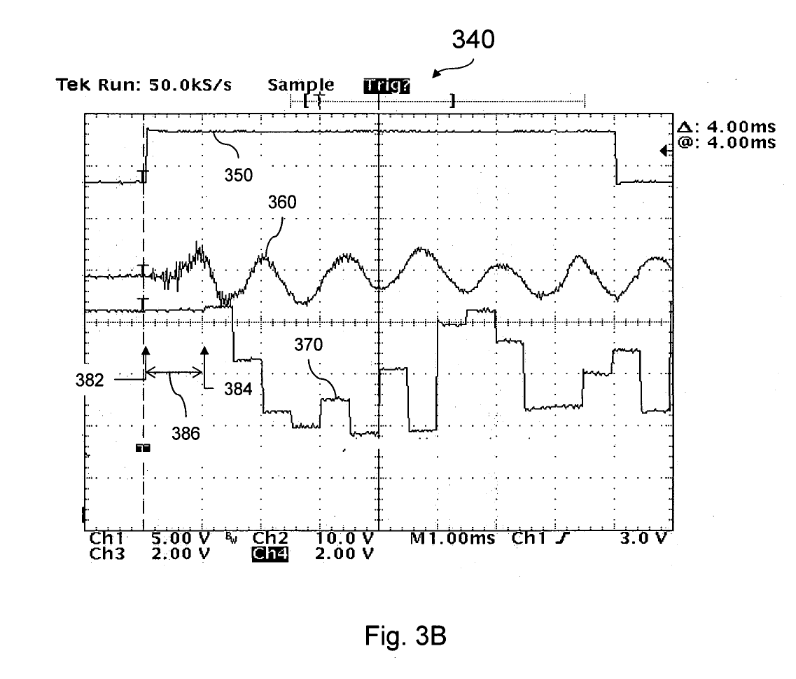

FIG. 3A illustrates a system 300 of one embodiment of the present invention for measuring response characteristics of sensors 111, such as, but not limited to the data latency of sensor 112. In one embodiment, one or more of sensor 111 are subject to a stimulus 320. In one embodiment, stimulus 320 is triggered by a stimulus initiator 310. In one embodiment, stimulus 320 is an impact and stimulus initiator 310 is an impact device such as a dink tool. In one embodiment, when stimulus initiator 310 triggers stimulus 320, sensor 112 responds by generating one or more data values which are transmitted into the data stream of communication link 115 via one or more data packets. In one embodiment, DAC interface 130 captures the sensor 112 data values within the data stream and outputs a voltage representation of the data to analog signal evaluation device 140, as described above.

In one embodiment, analog signal evaluation device 140 comprises one or both of an oscilloscope and a signal chart recorder coupled to receive the analog signals from DAC interface 130. In one embodiment, analog signal evaluation device 140 is further coupled to one or both of a connection from stimulus initiator 310 that provides an analog signal when stimulus 320 is initiated, and an analog sensor 113 which is also responsive to stimulus 320 and outputs one or more analog signals representative of stimulus 320. In one embodiment, where stimulus 320 is an impact, analog sensor 113 is an accelerometer that outputs a signal representing one or more accelerations measured by analog sensor 113 as a result of stimulus 320. In one embodiment, the analog signals from one or more of DAC interface 130, stimulus initiator 310 and analog sensor 113 are displayed as separate channel traces by analog signal evaluation device 140, as illustrated generally at 340 in FIG. 3B. In one embodiment, trace 350 provides a representation of the analog signal from stimulus initiator 310, trace 360 provides a representation of the analog signal from analog sensor 113 and trace 370 provides a representation of the analog signal from DAC interface 130.

As would be appreciated by one skilled in the art upon reading this specification, the data latency of sensor 112 can be determined by comparing the triggering (shown at 382) of stimulus 320 as indicated by one or both of trace 350 or trace 360 to the initial response (shown at 384) of sensor 112 as indicated by trace 370. The difference in time 386 between the triggering 382 and the initial response 384 represents the data latency of sensor 112. In one embodiment, analog signal evaluation device 140 comprises a timer adapted to start timing based upon an analog voltage signal received from stimulus initiator 310 and stop timing upon based upon an analog voltage signal received from DAC interface 130. For example, in one embodiment, analog signal evaluation device 140 starts timing upon receiving a voltage signal from stimulus initiator 310 of sufficient magnitude to initiate stimulus 320, and stops timing upon receiving a voltage signal from DAC interface 130 of at least a minimum threshold.

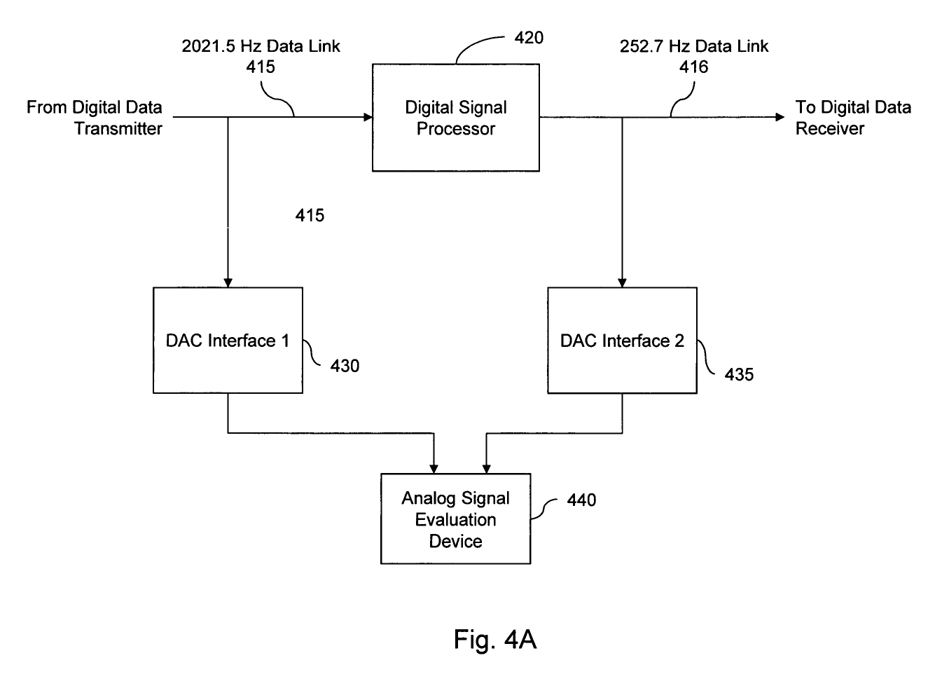

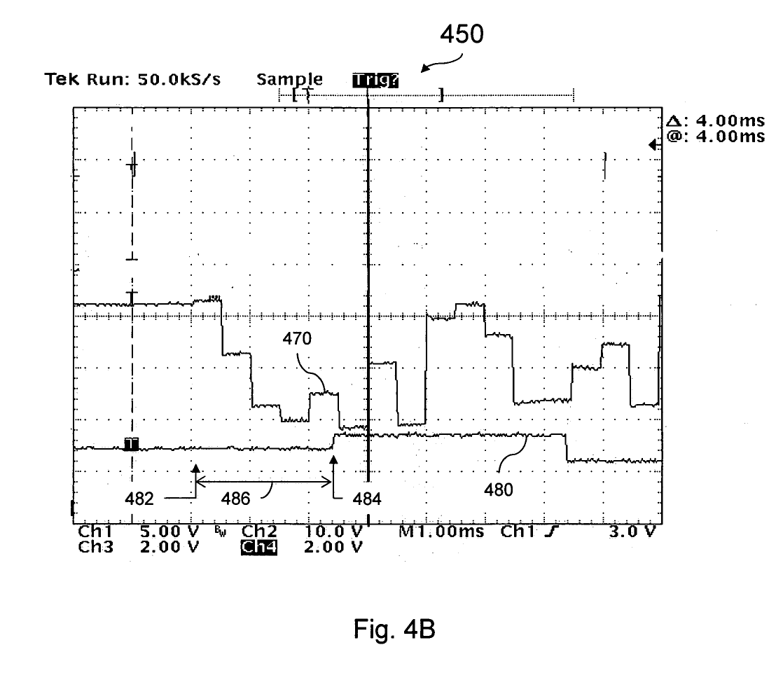

FIG. 4A illustrates another system 400 for observing the same data at two or more different points, of one embodiment of the present invention. In one embodiment, a first data link 415 communicates a first stream of data packets from a digital data transmitter to a digital signal processor 420. Digital signal processor 420 performs one or more operations on the first stream of data packets and outputs a second stream of data packets onto second data link 416. For example, in one embodiment, data link 415 communicates data at a rate of 2021.5 data packets per second (2021.5 Hz). In this example, digital signal processor 420 inputs the 2021.5 Hz data packets from data link 415 and converts every eight packets received into a second stream data packet. Digital signal processor 420 then transmits the second stream of data packets at a rate of 252.7 data packets per second (252.7 Hz) to second data link 416.

In one embodiment, the data latency caused by digital signal processor 420 with respect to data of interest is determined by converting the corresponding data values from the first data link 415 and the second data link 416 into analog signals. In one embodiment, a first DAC interface 430 reads data packets from first data link 415 and converts data values from the data of interest into a first analog signal output, as described with respect to DAC interface 130 above. In one embodiment, the data of interest is the response of a particular sensor (such as sensor 112) to an external stimulus. A second DAC interface 435 reads data packets from second data link 416 and converts data from the same event of interest into a second analog signal output, as described with respect to DAC interface 130 above.

In one embodiment, an analog signal evaluation device 440 is coupled to first DAC interface 430 and second DAC interface 435 to input the respective first and second analog signals. Illustrated in FIG. 4B, in one embodiment, analog signal evaluation device 440 is an oscilloscope configured to display the first and second analog signals (shown generally at 450) as traces 470 and 480, respectively. The data latency caused by digital signal processor 420 can be determined by comparing an initial response (shown at 482) of data values of interest extracted from data link 415 to an initial response (shown at 484) of data values of interest extracted from data link 416. The difference in time 486 between represents the data latency cause by digital signal processor 420.

Embodiments of the present invention are not limited to timing event occurrences or data latencies. To the contrary, embodiments of the present invention provide solutions to any application where the affects of propagating digital data from one point to another in a data stream are of interest. For example, referring back to FIG. 4A, in one embodiment the amplitude of the first analog signal trace 470 and the second analog signal trace 480 are compared to observe the gain resulting from digital signal processor 420 processing of the data of interest. In another embodiment, analog output from a DAC interface triggers the operation of one or more external devices (such as, but not limited to alarm or enunciator devices) when the value of specific data of interest communicated within a data stream reaches a certain threshold.

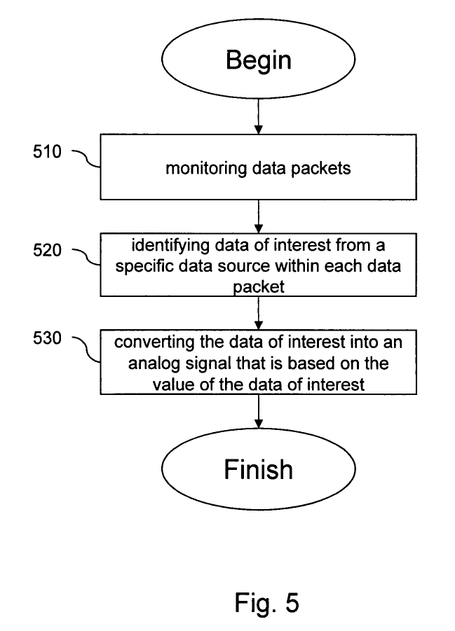

FIG. 5 is a flow chart illustrating a method of one embodiment of the present invention. The method begins at 510 with monitoring data packets communicated through a data stream. In one embodiment, the data stream is communicated through one or more data links such as, but not limited to a serial data link, an RS-232 protocol link, a Mil. Std. 1553 protocol link, a Manchester protocol link, an Ethernet link, a TCP/IP link, an optical communications link, a wireless communications link, or any communication link used to communicate digital data. The method proceeds to 520 with identifying data of interest within each data packet. In one embodiment, the data of interest is data from a specific data source. Data of interest within a data packet may arise in the form of the value of a single bit, or as multi-bit words. In one embodiment, an MPU reads the incoming data stream and when the data of interest is found the MPU sends the data to a digital to analog converter. In one embodiment, the MPU converts the data of interest into a multi-bit word that represents the value of the data of interest and communicates the multi-bit word to the digital to analog converter. The method continues with 530 with converting the data of interest into an analog signal that is based on the value of the data of interest. In one embodiment, the digital to analog converter inputs the multi-bit word provided by the MPU and outputs an analog signal representative of the value of the multi-bit word. In one embodiment, the analog signal is one of a voltage or a current signal.

Several means are available to implement the MPU processor, D/A converter, and DAC interface discussed above. These means include, but are not limited to, digital computer systems, programmable controllers, or field programmable gate arrays. Therefore other embodiments of the present invention are program instructions resident on computer readable media which when implemented by such processors, enable the processors to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for observing characteristics of data propagating through a stream of digital data, the method comprising:
monitoring data packets communicated though the stream of digital data at one or more points in the stream of digital data;
isolating data of interest from a specific data source within each of the data packets;
converting the data of interest into one or more analog signals that are representative of the data of interest; and
observing the one or more analog signals to determine the affects of one or more data processing operations on the data of interest.

2. The method of claim 1, further comprising:
observing the one or more analog signals to determine one or more of the source of data latency and the degree of data latency.

3. The method of claim 1, further comprising:
converting data of interest into a multi-bit word;
transmitting the multi-bit word to a digital to analog converter; and
outputting an analog signal that is directly related to the value of the multi-bit word.

4. The method of claim 1, further comprising:
initiating a stimulus event, wherein the data of interest represents a sensor response to the stimulus event.

5. The method of claim 4, further comprising:
determining a data latency by measuring a difference in time between the initiation of the stimulus event and the identification of the data of interest within the data stream based on the analog signal.

6. The method of claim 1, wherein the analog signal is one of a voltage signal and a current signal.

7. The method of claim 1, further comprising:
capturing digital data transmitted over a communications link via one or more of a serial data protocol, an RS-232 protocol, a Mil. Std. 1553 protocol, a Manchester protocol, a wireless data transmission protocol, and an optical data transmission protocol.

8. A method for observing the source of latency in a stream of digital data, the method comprising:
monitoring data packets communicated though the stream of digital data;
identifying data of interest from a specific data source within each of the data packets;
converting the data of interest into one or more analog signals that are representative of the data of interest; and
observing the one or more analog signals to determine one or more of the source of data latency, and the degree of data latency.

9. The method of claim 8, further comprising:
converting data of interest into a multi-bit word;
transmitting the multi-bit word to a digital to analog converter; and
outputting an analog signal that is directly related to the value of the multi-bit word.

10. A digital to analog converter interface for observing characteristics of data propagating through a stream of digital data, the interface comprising:
a processor adapted to input a stream of data packets from a data link, wherein the processor is further adapted to identify data of interest contained within one or more data packets of the stream of data packets; and
a digital to analog converter coupled to the processor, wherein the digital to analog converter is adapted to convert the data of interest identified by the processor into an analog signal that is representative of the value of the data of interest, and wherein characteristics of the analog signal indicate the affects of one or more data processing operations on the data of interest.

11. The interface of claim 10, wherein the data of interest is digital data representing the output of a sensor.

12. The interface of claim 10, wherein the processor is further adapted to convert the identified data of interest into a multi-bit word and output the multi-bit word to the digital to analog converter.

13. The interface of claim 12, wherein the digital to analog converter is adapted to input the multi-bit word and adjust a level of the analog signal based on the value of the multi-bit word.

14. A system for observing characteristics of data of interest communicated within a data stream, the system comprising:
means for monitoring a stream of data packets, wherein one or more data packets of the stream of data packets contain a data value of interest from a specific data source;
means for converting the data value of interest into an analog signal, wherein the analog signal is representative of the data value of interest, wherein the means for converting is responsive to the means for monitoring; and
means for observing the one or more analog signals to determine the affects of one or more data processing operations on the data of interest, wherein the means for observing is responsive to the means for converting.

15. The system of claim 14 further comprising:
means for identifying the data value of interest within a first data packet of the stream of data packets, wherein the means for identifying data is responsive to the means for monitoring a stream of data packets and the means for converting is further responsive to the means for identifying.

16. The system of claim 15 further comprising:
means for programming the means for identifying, wherein the means for programming is adapted to configure the means for identifying to identify which data value within the one or more data packets of the stream of data packets is the data value of interest.

17. The system of claim 14, further comprising:
means for observing one or more of the time response characteristics of the one or more analog signals, the relative timing of the one or more analog signals and the signal level of the one or more analog signal.

18. The system of claim 14 further comprising:
means for converting the data value of interest into a multi-bit word;
means for transmitting the multi-bit word from means for converting the data value of interest into a multi-bit word to the means for converting the data value of interest into an analog signal; and
means for outputting an analog signal that is directly related to the value of the multi-bit word, wherein the means for outputting an analog signal is responsive to the means for transmitting the multi-bit word.

19. The system of claim 14 further comprising:
means for initiating a stimulus, wherein the means for initiation a stimulus causes the generation of the data value of interest.
